(19) United States
(12) Patent Application Publication
(10) Pub. No.: US 2021/0201083 A1
(43) Pub. Date: Jul. 1, 2021

(54) VEHICLE-MOUNTED DEVICE AND METHOD FOR TRAINING OBJECT RECOGNITION MODEL

(71) Applicant: Mobile Drive Technology Co.,Ltd., New Taipei (TW)

(72) Inventors: KAI-CHUN WANG, New Taipei (TW); Winston H. Hsu, New Taipei (TW); TZU-KUEI HUANG, New Taipei (TW); TING-HAO CHUNG, New Taipei (TW); NAI-SHENG SYU, New Taipei (TW); YU-CHING WANG, New Taipei (TW); CHUN-HSIANG HUANG, New Taipei (TW)

(21) Appl. No.: 17/133,266

(22) Filed: Dec. 23, 2020

(30) Foreign Application Priority Data
Dec. 26, 2019 (CN) 201911370782.7

(51) Int. Cl. G06K 9/62; G06T 7/73; G06K 9/00; G06N 3/08; G06N 3/04; G01S 17/89; G01S 17/931; G01S 17/04; G01S 7/48

(52) U.S. Cl. CPC G06K 9/6262; G06K 9/6256; G06T 7/73; G06K 9/00791; G06N 3/08; G06N 3/04; G06T 2207/20084; G01S 17/931; G01S 17/04; G01S 7/4808; G06T 2207/10028; G06T 2207/30252; G06T 2207/20081; G01S 17/89

(57) ABSTRACT

A method of training an object recognition model includes obtaining a sample set. The sample set is divided into a training set and a verification set. The object recognition model is obtained by training a neural network using the training set, and the object recognition model is verified using the verification set.

### FIELD

The present disclosure relates to object detection technologies, in particular to a method for training an object recognition model, and a vehicle-mounted device.

### BACKGROUND

With the development of self-driving technology, a lidar installed on a vehicle can detect objects as the vehicle is being driven. In an existing object detection method, point clouds detected by the lidar are divided by XY coordinates. However, since the lidar emits in a radial manner, the following problems can be encountered: a data density closer to an origin of the lidar is higher, and a data density away from the origin of the lidar is lower, such that miss or misdetection may occur in some areas.

### BRIEF DESCRIPTION OF THE DRAWINGS

FIG. 1 is a flowchart of a method of training an object recognition model provided by a preferred embodiment of the present disclosure.

FIG. 2A illustrates an actual area of an object and an identified area of the object identified by the object recognition model.

FIG. 2B illustrates an intersection area of the actual area and the identified area of the object.

FIG. 2C illustrates a union area of the actual area and the identified area of the object.

FIG. 3 is a block diagram of a training system for training the object recognition model provided by a preferred embodiment of the present disclosure.

FIG. 4 is a structural diagram of a vehicle-mounted device provided by a preferred embodiment of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

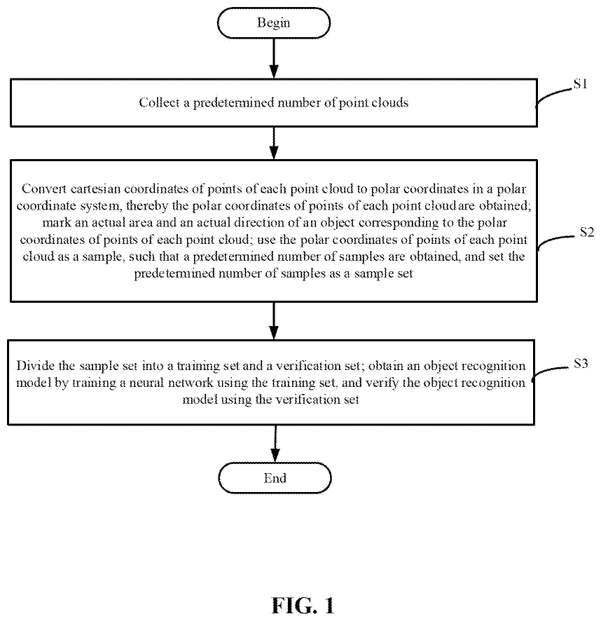

FIG. 1 is a flowchart of a method of training an object recognition model provided by a preferred embodiment of the present disclosure.

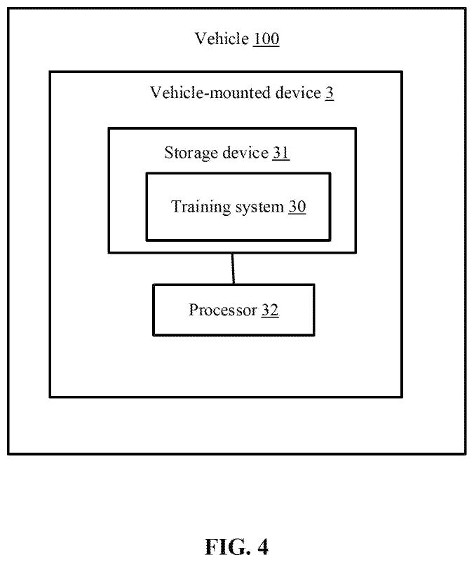

In one embodiment, the method of training the object recognition model can be applied to a vehicle-mounted device (e.g., a vehicle-mounted device 3 in FIG. 4). For a vehicle-mounted device that needs to perform the method of training the object recognition model, the function for training the object recognition model provided by the method of the present disclosure can be directly integrated on the vehicle-mounted device, or run on the vehicle-mounted device in the form of a software development kit (SDK).

At block S1, the vehicle-mounted device collects a predetermined number of point clouds.

It should be noted that a point cloud is a set of points in space.

In this embodiment, each point cloud is obtained by using a lidar when a vehicle (e.g., a vehicle 100 in FIG. 4) is traveling.

In this embodiment, the predetermined number may be 100,000, 200,000, or other numbers.

At block S2, the vehicle-mounted device converts cartesian coordinates of points of each point cloud to polar coordinates in a polar coordinate system, thereby the vehicle-mounted device obtains the polar coordinates of points of each point cloud. The vehicle-mounted device marks an actual area and an actual direction of each object corresponding to the polar coordinates of points of each point cloud. The vehicle-mounted device uses the polar coordinates of points of each point cloud as a sample, such that the vehicle-mounted device obtains a predetermined number of samples, and sets the predetermined number of samples as a sample set.

It should be noted that, when the cartesian coordinates of points of each point cloud are converted to the polar coordinates, a sampling frequency of dense points in the vicinity becomes higher, and the sampling frequency of sparse points in the distance becomes lower, thereby the problem of uneven sampling frequency of points in the vicinity and points in the distance is improved.

At block S3, the vehicle-mounted device divides the sample set into a training set and a verification set. The vehicle-mounted device obtains an object recognition model by training a neural network using the training set, and verifies the object recognition model using the verification set.

In one embodiment, the number of samples included in the training set is m % of the sample set, and the number of samples included in the verification set is n % of the sample set. In one embodiment, a sum of m % and n % is equal to 100%.

For example, the number of samples included in the training set is 70% of the sample set, and the number of samples included in the verification set is 30% of the sample set.

In one embodiment, the neural network is a convolutional neural network (CNN). In one embodiment, a method of training the neural network to obtain the object recognition model by using the training set is an existing technology, which will not be repeated here.

In one embodiment, the verifying of the object recognition model using the verification set includes (a1)-(a6):

(a1) identifying an area and a direction of each object corresponding to each sample of the verification set using the object recognition model, such that an identified area and an identified direction of the each object corresponding to each sample are obtained.

(a2) calculating an IOU (intersection over union) between the identified area of each object and the actual area of each object, calculating a distance d between the identified area of each object and the actual area of each object, and associating each object with the corresponding IOU and the corresponding distance d.

In this embodiment, the IOU=I/U, wherein “I” represents an area of an intersection area of the identified area of each object and the actual area of each object, and “U” represents an area of a union area of the identified area of each object and the actual area of each object.

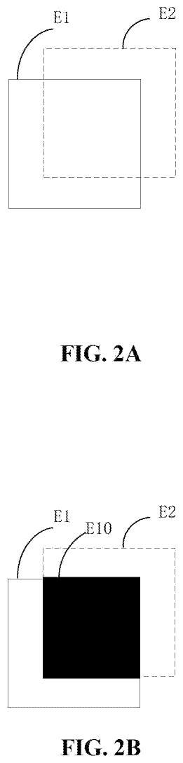

For example, to clearly illustrate the present disclosure, please refer to FIGS. 2A-2C, it is assumed that an area E1 framed by a solid line in FIG. 2A represents an actual area of an object O, and an area E2 framed by a dotted line in FIG. 2A represents an identified area of the object O identified by the object recognition model. Then a black filled area E10 shown in FIG. 2B is an intersection area of E1 and E2, and a black filled area E12 shown in FIG. 2C is a union area of E1 and E2. It can be seen that an IOU between the identified area of the object O and the actual area of the object O is equal to an area of E10 divided by an area of E12, such that the vehicle-mounted device obtains the IOU. The vehicle-mounted device can associate the object O with the IOU.

In this embodiment, the distance d=max(Δx/Lgt, Δy/Wgt), wherein “Δx” represents a difference between an abscissa of a first center point and an abscissa of a second center point, the first center point is a center point of the identified area of each object, and the second center point is a center point of the actual area of each object; “Δy” represents a difference between an ordinate of the first center point and an ordinate of the second center point; “Lgt” represents a length of the actual area of each object, and “Wgt” represents a width of the actual area of each object.

For example, it is assumed that an abscissa of a center point of the identified area of the object O is X1, an ordinate of the center point of the identified area of the object O is Y1, a length of the actual area of the object O is L, and a width of the actual area of the object O is W, and an abscissa of a center point of the actual area of the object O is X2, and an ordinate of the center point of the actual area of the object O is Y2, then a distance d=max((X1−X2)/L, (Y1−Y2)/W). The vehicle-mounted device can further associate the object O with the distance d.

(a3) calculating an angle deviation value Δa between the identified direction of each object and the actual direction of each object, and associating each object with the corresponding angle deviation value Δa.

In this embodiment, the angle deviation value Δa can be calculated according to a first direction vector and a second direction vector defined for each object.

Specifically, the first direction vector can be defined based on a straight line from an origin of the polar coordinate system to the center point of the actual area of each object. Similarly, the second direction vector can be defined based on a straight line from the origin of the polar coordinate system to the center point of the identified area of each object. Therefore, the angle deviation value Δa can be calculated based on the first direction vector and the second direction vector.

(a4) determining whether the object recognition model correctly recognizes each object according to the IOU, the distance d, and the angle deviation value Δa associated with each object.

In this embodiment, the determining of whether the object recognition model correctly recognizes each object according to the IOU, the distance d, and the angle deviation value Δa associated with each object includes:

when each of the IOU, the distance d, and the angle deviation value Δa associated with any one object falls within a corresponding preset value range, determining that the object recognition model correctly recognizes the any one object; and

when at least one of the IOU, the distance d, and the angle deviation value Δa associated with the any one object does not fall within the corresponding preset value range, determining that the object recognition model does not correctly recognize the any one object.

For example, it is assumed that the IOU associated with the object O falls within a corresponding first preset value range, the distance d associated with the object O falls within a corresponding second preset value range, and the angle deviation value Δa falls within a corresponding third preset value range, the vehicle-mounted device can determine that the object recognition model correctly recognizes the object O.

(a5) calculating an accuracy rate of the object recognition model based on a recognition result of the object recognition model recognizing each object corresponding to each sample included in the verification set.

To clearly illustrate the present disclosure, it is assumed that the verification set includes two point clouds, namely a first point cloud and a second point cloud, and each of the two point clouds corresponds to two objects. It is assumed that the object recognition model correctly recognizes the two objects in the first point cloud and one object in the second point cloud, but the object recognition model does not correctly recognize another object in the second point cloud. Then the accuracy rate of the object recognition model is 75%.

(a6) ending the training of the neural network when the accuracy rate of the object recognition model is greater than or equal to a preset value; and continuing to train the neural network when the accuracy rate of the object recognition model is less than the preset value, until the accuracy rate of the object recognition model is greater than or equal to the preset value.

In an embodiment, when the accuracy rate of the object recognition model is less than the preset value, the vehicle-mounted device can update the sample set by adding samples, and the vehicle-mounted device can continuously train the object recognition model using the updated sample set until the accuracy rate of the object recognition model is greater than or equal to the preset value.

After finishing the training of the object recognition model, the vehicle-mounted device can use the object recognition model to recognize objects as the vehicle is being driven.

Specifically, the vehicle-mounted device can convert the cartesian coordinates of points of the point clouds scanned by the lidar during the driving of the vehicle into the polar coordinates and input the polar coordinates into the object recognition model to recognize objects.

It should be noted that because the present disclosure adds a determination of the distance d and the angle deviation value Δa during the training of the object recognition model, the present disclosure can effectively solve a technical problem that the vehicle becomes oblique when the object is detected based on the polar coordinates. In addition, the accuracy of recognizing objects can be improved.

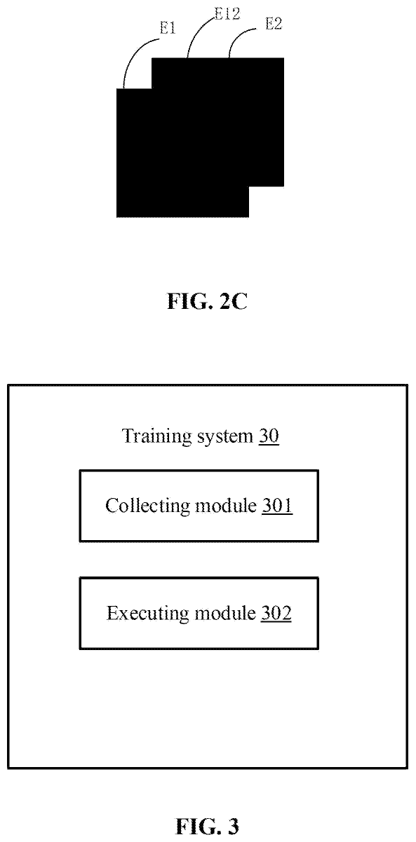

FIG. 3 is a block diagram of a training system 30 for training the object recognition model provided by a preferred embodiment of the present disclosure.

In some embodiments, the training system 30 runs in a vehicle-mounted device. The training system 30 may include a plurality of modules. The plurality of modules can comprise computerized instructions in a form of one or more computer-readable programs that can be stored in a non-transitory computer-readable medium (e.g., a storage device 31 of the vehicle-mounted device 3 in FIG. 4), and executed by at least one processor (e.g., a processor 32 in FIG. 4) of the vehicle-mounted device to implement a function of training the object recognition model (described in detail in FIG. 1).

In at least one embodiment, the training system 30 may include a plurality of modules. The plurality of modules may include, but is not limited to, a collecting module 301 and an executing module 302. The modules 301-302 can comprise computerized instructions in the form of one or more computer-readable programs that can be stored in the non-transitory computer-readable medium (e.g., the storage device 31 of the vehicle-mounted device 3 in FIG. 4), and executed by the at least one processor (e.g., the processor 32 in FIG. 4) of the vehicle-mounted device to implement the function of training the object recognition model (e.g., described in detail in FIG. 1).

The collecting module 301 collects a predetermined number of point clouds.

It should be noted that a point cloud is a set of points in space.

In this embodiment, each point cloud is obtained by using a lidar when a vehicle is traveling.

In this embodiment, the predetermined number may be 100,000, 200,000, or other numbers.

The executing module 302 converts cartesian coordinates of points of each point cloud to polar coordinates in a polar coordinate system, thereby the executing module 302 obtains the polar coordinates of points of each point cloud. The executing module 302 marks an actual area and an actual direction of an object corresponding to the polar coordinates of points of each point cloud. The executing module 302 uses the polar coordinates of points of each point cloud as a sample, such that the executing module 302 obtains a predetermined number of samples, and sets the predetermined number of samples as a sample set.

It should be noted that, when the cartesian coordinates of points of each point cloud are converted to the polar coordinates, a sampling frequency of dense points in the vicinity becomes higher, and the sampling frequency of sparse points in the distance becomes lower, thereby the problem of uneven sampling frequency of points in the vicinity and points in the distance is improved.

The executing module 302 divides the sample set into a training set and a verification set. The executing module 302 obtains an object recognition model by training a neural network using the training set, and verifies the object recognition model using the verification set.

In one embodiment, the number of samples included in the training set is m % of the sample set, and the number of samples included in the verification set is n % of the sample set. In one embodiment, a sum of m % and n % is equal to 100%.

For example, the number of samples included in the training set is 70% of the sample set, and the number of samples included in the verification set is 30% of the sample set.

In one embodiment, the neural network is a convolutional neural network (CNN). In one embodiment, a method of training the neural network to obtain the object recognition model by using the training set is an existing technology, which will not be repeated here.

In one embodiment, the verifying of the object recognition model using the verification set includes (a1)-(a6):

(a1) identifying an area and a direction of each object corresponding to each sample of the verification set using the object recognition model, such that an identified area and an identified direction of the each object corresponding to each sample are obtained.

(a2) calculating an IOU (intersection over union) between the identified area of each object and the actual area of each object, calculating a distance d between the identified area of each object and the actual area of each object, and associating each object with the corresponding IOU and the corresponding distance d.

In this embodiment, the IOU=I/U, wherein “I” represents an area of an intersection area of the identified area of each object and the actual area of each object, and “U” represents an area of a union area of the identified area of each object and the actual area of each object.

For example, to clearly illustrate the present disclosure, please refer to FIGS. 2A-2C, it is assumed that an area E1 framed by a solid line in FIG. 2A represents an actual area of an object O, and an area E2 framed by a dotted line in FIG. 2A represents an identified area of the object O identified by the object recognition model. Then a black filled area E10 shown in FIG. 2B is an intersection area of E1 and E2, and a black filled area E12 shown in FIG. 2C is a union area of E1 and E2. It can be seen that an IOU between the identified area of the object O and the actual area of the object O is equal to an area of E10 divided by an area of E12, such that the executing module 302 obtains the IOU. The executing module 302 can associate the object O with the IOU.

In this embodiment, the distance d=max(Δx/Lgt, Δy/Wgt), wherein “Δx” represents a difference between an abscissa of a first center point and an abscissa of a second center point, the first center point is a center point of the identified area of each object, and the second center point is a center point of the actual area of each object; “Δy” represents a difference between an ordinate of the first center point and an ordinate of the second center point; “Lgt” represents a length of the actual area of each object, and “Wgt” represents a width of the actual area of each object.

For example, it is assumed that an abscissa of a center point of the identified area of the object O is X1, an ordinate of the center point of the identified area of the object O is Y1, a length of the actual area of the object O is L, and a width of the actual area of the object O is W, and an abscissa of a center point of the actual area of the object O is X2, and an ordinate of the center point of the actual area of the object O is Y2, then a distance d=max((X1−X2)/L, (Y1−Y2)/W). The executing module 302 can further associate the object O with the distance d.

(a3) calculating an angle deviation value Δa between the identified direction of each object and the actual direction of each object, and associating each object with the corresponding angle deviation value Δa.

In this embodiment, the angle deviation value Δa can be calculated according to a first direction vector and a second direction vector defined for each object.

Specifically, the first direction vector can be defined based on a straight line from an origin of the polar coordinate system to the center point of the actual area of each object. Similarly, the second direction vector can be defined based on a straight line from the origin of the polar coordinate system to the center point of the identified area of each object. Therefore, the angle deviation value Δa can be calculated based on the first direction vector and the second direction vector.

(a4) determining whether the object recognition model correctly recognizes each object according to the IOU, the distance d, and the angle deviation value Δa associated with each object.

In this embodiment, the determining of whether the object recognition model correctly recognizes each object according to the IOU, the distance d, and the angle deviation value Δa associated with each object includes:

when each of the IOU, the distance d, and the angle deviation value Δa associated with any one object falls within a corresponding preset value range, determining that the object recognition model correctly recognizes the any one object; and

when at least one of the IOU, the distance d, and the angle deviation value Δa associated with the any one object does not fall within the corresponding preset value range, determining that the object recognition model does not correctly recognize the any one object.

For example, it is assumed that the IOU associated with the object O falls within a corresponding first preset value range, the distance d associated with the object O falls within a corresponding second preset value range, and the angle deviation value Δa falls within a corresponding third preset value range, the executing module 302 can determine that the object recognition model correctly recognizes the object O.

(a5) calculating an accuracy rate of the object recognition model based on a recognition result of the object recognition model recognizing each object corresponding to each sample included in the verification set.

To clearly illustrate the present disclosure, it is assumed that the verification set includes two point clouds, namely a first point cloud and a second point cloud, and each of the two point clouds corresponds to two objects. It is assumed that the object recognition model correctly recognizes the two objects in the first point cloud and one object in the second point cloud, but the object recognition model does not correctly recognize another object in the second point cloud. Then the accuracy rate of the object recognition model is 75%.

(a6) ending the training of the neural network when the accuracy rate of the object recognition model is greater than or equal to a preset value; and continuing to train the object recognition model when the accuracy rate of the object recognition model is less than the preset value, until the accuracy rate of the object recognition model is greater than or equal to the preset value.

In an embodiment, when the accuracy rate of the object recognition model is less than the preset value, the collecting module 301 can update the sample set by adding samples, and the executing module 302 can continuously train the neural network using the updated sample set until the accuracy rate of the object recognition model is greater than or equal to the preset value.

After finishing the training of the object recognition model, the executing module 302 can use the object recognition model to recognize objects as the vehicle is being driven.

Specifically, the executing module 302 can convert the cartesian coordinates of points of the point clouds scanned by the lidar during the driving of the vehicle into the polar coordinates and input the polar coordinates into the object recognition model to recognize objects.

It should be noted that because the present disclosure adds a determination of the distance d and the angle deviation value Δa during the training of the object recognition model, the present disclosure can effectively solve a technical problem that the vehicle becomes oblique when the object is detected based on the polar coordinates. In addition, the accuracy of recognizing objects can be improved.

FIG. 4 shows a schematic block diagram of one embodiment of a vehicle-mounted device 3 in a vehicle 100. The vehicle-mounted device 3 is installed in the vehicle 100. The vehicle-mounted device 3 is essentially a vehicle-mounted computer. In an embodiment, the vehicle-mounted device 3 may include, but is not limited to, a storage device 31 and at least one processor 32 electrically connected to each other.

It should be understood by those skilled in the art that the structure of the vehicle-mounted device 3 shown in FIG. 4 does not constitute a limitation of the embodiment of the present disclosure. The vehicle-mounted device 3 may further include other hardware or software, or the vehicle-mounted device 3 may have different component arrangements. For example, the vehicle-mounted device 3 can further include a display device.

In at least one embodiment, the vehicle-mounted device 3 may include a terminal that is capable of automatically performing numerical calculations and/or information processing in accordance with pre-set or stored instructions. The hardware of the terminal can include, but is not limited to, a microprocessor, an application specific integrated circuit, programmable gate arrays, digital processors, and embedded devices.

It should be noted that the vehicle-mounted device 3 is merely an example, and other existing or future electronic products may be included in the scope of the present disclosure, and are included in the reference.

In some embodiments, the storage device 31 can be used to store program codes of computer readable programs and various data, such as the training system 30 installed in the vehicle-mounted device 3, and automatically access to the programs or data with high speed during running of the vehicle-mounted device 3. The storage device 31 can include a read-only memory (ROM), a programmable read-only memory (PROM), an erasable programmable read only memory (EPROM), an one-time programmable read-only memory (OTPROM), an electronically-erasable programmable read-only memory (EEPROM), a compact disc read-only memory (CD-ROM), or other optical disk storage, magnetic disk storage, magnetic tape storage, or any other storage medium readable by the vehicle-mounted device 3 that can be used to carry or store data.

In some embodiments, the at least one processor 32 may be composed of an integrated circuit, for example, may be composed of a single packaged integrated circuit, or multiple integrated circuits of same function or different functions. The at least one processor 32 can include one or more central processing units (CPU), a microprocessor, a digital processing chip, a graphics processor, and various control chips. The at least one processor 32 is a control unit of the vehicle-mounted device 3, which connects various components of the vehicle-mounted device 3 using various interfaces and lines. By running or executing a computer program or modules stored in the storage device 31, and by invoking the data stored in the storage device 31, the at least one processor 32 can perform various functions of the vehicle-mounted device 3 and process data of the vehicle-mounted device 3. For example, the function of training the object recognition model.

Although not shown, the vehicle-mounted device 3 may further include a power supply (such as a battery) for powering various components. Preferably, the power supply may be logically connected to the at least one processor 32 through a power management device, thereby, the power management device manages functions such as charging, discharging, and power management. The power supply may include one or more a DC or AC power source, a recharging device, a power failure detection circuit, a power converter or inverter, a power status indicator, and the like. The vehicle-mounted device 3 may further include various sensors, such as a BLUETOOTH module, a Wi-Fi module, and the like, and details are not described herein.

In at least one embodiment, as shown in FIG. 3, the at least one processor 32 can execute various types of applications (such as the training system 30) installed in the vehicle-mounted device 3, program codes, and the like. For example, the at least one processor 32 can execute the modules 301-302 of the training system 30.

In at least one embodiment, the storage device 31 stores program codes. The at least one processor 32 can invoke the program codes stored in the storage device 31 to perform functions. For example, the modules 301-302 described in FIG. 3 are program codes stored in the storage device 31 and executed by the at least one processor 32, to implement the functions of the various modules for the purpose of training the object recognition model as described in FIG. 1.

In at least one embodiment, the storage device 31 stores one or more instructions (i.e., at least one instruction) that are executed by the at least one processor 32 to achieve the purpose of training the object recognition model as described in FIG. 1.

In at least one embodiment, the at least one processor 32 can execute the at least one instruction stored in the storage device 31 to perform the operations of as shown in FIG. 1.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A method for training an object recognition model, the method comprising:
collecting a predetermined number of point clouds ;
obtaining a predetermined number of polar coordinates by converting cartesian coordinates of points of each point cloud of the predetermined number of point clouds to polar coordinates in a polar coordinate system; marking an actual area and an actual direction of each object corresponding to the polar coordinates of points of each point cloud;
obtaining a predetermined number of samples by setting the polar coordinates of points of each point cloud as a sample, and setting the predetermined number of samples as a sample set;
dividing the sample set into a training set and a verification set; obtaining the object recognition model by training a neural network using the training set, and verifying the object recognition model using the verification set;
wherein the verifying the object recognition model using the verification set comprises:
identifying an area and a direction of each object corresponding to each sample of the verification set using the object recognition model, such that an identified area and an identified direction of the each object corresponding to each sample are obtained;
calculating an intersection over union (IOU) between the identified area of each object and the actual area of each object; calculating a distance d between the identified area of each object and the actual area of each object; and associating each object with the corresponding IOU and the corresponding distance d;
calculating an angle deviation value Δa between the identified direction of each object and the actual direction of each object, and associating each object with the corresponding angle deviation value Δa;
determining whether the object recognition model correctly recognizes each object according to the IOU, the distance d, and the angle deviation value Δa associated with each object;
calculating an accuracy rate of the object recognition model based on a recognition result of the object recognition model recognizing each object corresponding to each sample of the verification set; and
ending the training of the neural network when the accuracy rate of the object recognition model is greater than or equal to a preset value.

2. The method according to claim 1, wherein the IOU=I/U, wherein “I” represents an area of an intersection area of the identified area of each object and the actual area of each object, and “U” represents an area of a union area of the identified area of each object and the actual area of each object.

3. The method according to claim 1, wherein the distance d=max(Δx/Lgt, Δy/Wgt), wherein “Δx” represents a difference between an abscissa of a first center point and an abscissa of a second center point, the first center point is a center point of the identified area of each object, and the second center point is a center point of the actual area of each object; “Δy” represents a difference between an ordinate of the first center point and an ordinate of the second center point; “Lgt” represents a length of the actual area of each object, and “Wgt” represents a width of the actual area of each object.

4. The method according to claim 1, wherein the determining whether the object recognition model correctly recognizes each object according to the IOU, the distance d, and the angle deviation value Δa associated with each object comprises:
when each of the IOU, the distance d, and the angle deviation value Δa associated with any one object falls within a corresponding preset value range, determining that the object recognition model correctly recognizes the any one object; and
when at least one of the IOU, the distance d, and the angle deviation value Δa associated with the any one object does not fall within the corresponding preset value range, determining that the object recognition model does not correctly recognize the any one object.

5. The method according to claim 1, wherein the neural network is a convolutional neural network.

6. A vehicle-mounted device comprising:
a storage device;
at least one processor; and
the storage device storing one or more programs, which when executed by the at least one processor, cause the at least one processor to:
collect a predetermined number of point clouds;
obtain a predetermined number of polar coordinates by converting cartesian coordinates of points of each point cloud of the predetermined number of point clouds to polar coordinates in a polar coordinate system; mark an actual area and an actual direction of each object corresponding to the polar coordinates of points of each point cloud;
obtain a predetermined number of samples by setting the polar coordinates of points of each point cloud as a sample, and set the predetermined number of samples as a sample set;
divide the sample set into a training set and a verification set; obtain an object recognition model by training a neural network using the training set, and verify the object recognition model using the verification set;
wherein the verifying the object recognition model using the verification set comprises:
identifying an area and a direction of each object corresponding to each sample of the verification set using the object recognition model, such that an identified area and an identified direction of the each object corresponding to each sample are obtained;
calculating an intersection over union (IOU) between the identified area of each object and the actual area of each object; calculating a distance d between the identified area of each object and the actual area of each object; and associating each object with the corresponding IOU and the corresponding distance d;
calculating an angle deviation value Δa between the identified direction of each object and an actual direction of each object, and associating each object with the corresponding angle deviation value Δa;
determining whether the object recognition model correctly recognizes each object according to the IOU, the distance d, and the angle deviation value Δa associated with each object;
calculating an accuracy rate of the object recognition model based on a recognition result of the object recognition model recognizing each object corresponding to each sample of the verification set; and
ending the training of the neural network when the accuracy rate of the object recognition model is greater than or equal to a preset value.

7. The vehicle-mounted device according to claim 6, wherein the IOU=I/U, wherein “I” represents an area of an intersection area of the identified area of each object and the actual area of each object, and “U” represents an area of a union area of the identified area of each object and the actual area of each object.

8. The vehicle-mounted device according to claim 6, wherein the distance d=max(Δx/Lgt, Δy/Wgt), wherein “Δx” represents a difference between an abscissa of a first center point and an abscissa of a second center point, the first center point is a center point of the identified area of each object, and the second center point is a center point of the actual area of each object; “Δy” represents a difference between an ordinate of the first center point and an ordinate of the second center point; “Lgt” represents a length of the actual area of each object, and “Wgt” represents a width of the actual area of each object.

9. The vehicle-mounted device according to claim 6, wherein the determining whether the object recognition model correctly recognizes each object according to the IOU, the distance d, and the angle deviation value Δa associated with each object comprises:
when each of the IOU, the distance d, and the angle deviation value Δa associated with any one object falls within a corresponding preset value range, determining that the object recognition model correctly recognizes the any one object; and
when at least one of the IOU, the distance d, and the angle deviation value Δa associated with the any one object does not fall within the corresponding preset value range, determining that the object recognition model does not correctly recognize the any one object.

10. The vehicle-mounted device according to claim 6, wherein the neural network is a convolutional neural network.
